(19) United States
(12) Patent Application Publication
(10) Pub. No.: US 2024/0308897 A1
(43) Pub. Date: Sep. 19, 2024

(54) MICRO SUPER CRITICAL WATER OXIDATION SOLIDS TREATMENT SYSTEM

(71) Applicant: Georgia Tech Research Corporation, Atlanta, GA (US)

(72) Inventors: Shannon YEE, Decatur, GA (US); David HASLER, Zurich (CH); Roland LEHMANN, Gossau (CH); Christian SEILER, Herisau (CH); Christian FORRER, Degersheim (CH); Christoph FARRÉR, Effretikon (CH); Andreas STAUB, Hettlingen (CH); Marco CADUFF, Wil (CH); Janine GLATTHARD, Wil (CH); Adrian GEMPRELI, Wil (CH); Florian FISCHER, Wil (CH); Daniel RÜDISÜLI, Wil (CH); Valdinei FRASSON, Wil (CH); Josef FISCHER, Wil (CH); Tobias BLEIKER, Wil (CH)

(21) Appl. No.: 18/578,243

(22) PCT Filed: Jul. 15, 2022
(86) PCT No.: PCT/US2022/073815

§ 371 Date: Jan. 10, 2024

Related U.S. Application Data
(60) Provisional application No. 63/222,736, filed on Jul. 16, 2021.

(51) Int. Cl. C02F 11/08; C02F 11/13; C02F 103/00

(52) U.S. Cl. CPC C02F 11/086; C02F 11/13; C02F 2103/005; C02F 2201/007; C02F 2301/066; C02F 2303/04

(57) ABSTRACT

System and method for micro-Super Critical Water Oxidation solids treatment of fecal waste are described. The system includes an injector vessel (112) and a reactor (114). The reactor can receive an injection of a slurry batch and an input of compressed air that is heated over time to a temperature at or above the critical point of water into the super critical fluid phase. A combined concentrator and phase separator (150)) can receive a treated output from the reactor and separate solid ash from liquid and gaseous effluent. A drying tunnel (170) can receive and dry the solid ash. The treatment process includes heating the slurry batch, within the reactor, to a temperature of at or above the critical point of water into the super critical fluid phase and maintaining the slurry batch a minimum temperature, within the reactor, for a predetermined treatment time to produce a treated output.

### CROSS-REFERENCE TO RELATED APPLICATION

This application claims the benefit of and priority to U.S. Provisional Application No. 63/222,736, titled “MICRO SUPER CRITICAL WATER OXIDATION SOLIDS TREATMENT SYSTEM,” filed on Jul. 16, 2021, the entire contents of which are hereby incorporated herein by reference.

### BACKGROUND

An estimated 4.5 billion people worldwide do not have access to safe, affordable sanitation systems. High levels of child death and disease have been linked to oral fecal contamination where pathogen laden fecal matter enters the food or water supply. Non-sewered sanitation systems are needed where traditional sanitary sewer systems are unavailable or impractical.

### SUMMARY

Disclosed herein is a solids waste treatment system comprising an injector vessel, a reactor, a combined concentrator and phase separator, and a drying tunnel. The reactor configured to receive an injection of a slurry batch from the injector vessel and an input of compressed air to be heated to a temperature over a heating time, the temperature being at or above the critical point of water into the super critical fluid phase. The combined concentrator and phase separator comprising a concentrator vessel configured to receive and contain a liquid to be concentrated and a separator. The separator also configured to receive a treated output from the reactor and separate solid ash volume from liquid and gaseous effluent. The drying tunnel configured to receive and dry the solid ash volume. Also disclosed is a process for treatment of human waste using the disclosed solids waste treatment system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example diagram of a micro-Super Critical Water Oxidation (mSCWO) solids treatment system according to various embodiments described herein.

FIG. 2 illustrates example portions the gas handling module and reactor module of a mSCWO solids treatment system of FIG. 1 according to various embodiments described herein.

FIG. 3 illustrates an example cross sectional view of the mSCWO reactor of the mSCWO solids treatment system of FIG. 2 according to various embodiments described herein.

FIGS. 4A and 4B illustrate an example concentrator module of the mSCWO solids treatment system of FIG. 1 according to various embodiments described herein.

FIG. 5 illustrates an example of the drying tunnel of the mSCWO solids treatment system of FIG. 1 according to various embodiments described herein.

FIG. 6 illustrates an example method for treatment of human waste according to various embodiments described herein.

FIG. 7 illustrates an example schematic of the mSCWO solids treatment system used as a module within a non-sewered single unit toilet system according to various embodiments described herein.

### DETAILED DESCRIPTION

Sanitation systems are needed for regions of the world where open defecation or lack of improved sanitation is common, which can lead to illness. Traditional sewage and wastewater treatment plants which receive waste from sewers can be expensive to implement and operate. Technologies for multi-unit toilets are being developed to process waste on a large scale. However, there is a need for technology to provide access to safe, affordable sanitation systems that can be deployed in a family home without sewer connections. Holistically, as water scarcity rises across the globe, sanitation systems that reduce reliance on large volumes of water for transport of waste over long distances will become increasingly important, not just in developing countries, but globally.

To address these deficiencies, systems for use in a stand-alone non-sewered toilet system are discussed herein. The systems can be configured to inactivate pathogens from human waste and prepare the waste for safe disposal. The systems can also recover valuable resources such as clean water. The systems can be configured to operate without connection to input water or output sewers. Some example systems can be battery based or powered by off-grid renewables. The systems can be optimized for low-cost fabrication and low operation costs. The systems can promote sustainable sanitation services that operate in poor, urban settings, as well as in developed and developing nations.

The ISO 30500 standard provides a technical standard for non-sewered sanitation systems designed to address basic sanitation needs and promote economic, social, and environmental sustainability through strategies that include minimizing water and energy consumption, and converting human excreta to safe output. These sanitation systems are intended to operate without connection to any sewer or drainage network and meet health and environmental safety and regulatory parameters. In some examples, systems described herein can be configured to provide treated output that meets or exceeds the ISO 30500 standard.

For example, human waste streams can include urine, feces, diarrhea, and the like. Sanitation incidentals can include toilet paper, feminine hygiene waste, diapers, other paper products, and the like. In some toilet systems, a portion of sanitation incidentals, including non-organic products such as diapers, can be received and processed separately from the human waste streams. In some examples, the wastes streams comprise human feces and urine, menstrual blood, bile, flushing water, anal cleansing water, toilet paper, other bodily fluids and/or solids. Additionally, the waste streams can comprise water, including flush water, rinse water, wash water, fresh water, consumable water, potable water, useable water, and the like.

For example, a stand-alone non-sewered toilet system can comprise a liquid treatment system and a solids treatment system, each of which can operate as a separate system or be interconnected for treatment of human waste. The stand-alone non-sewered toilet system can also comprise at least one separation system. In some examples, the content of human waste streams can be separated or processed separately. Separation of streams can provide more efficient processing than mixed-content human waste streams by dividing the source material into primarily feces, urine, and wastewater streams. Since 100% separation is not practical, a degree of cross contamination between the streams is acceptable for the subsequent downstream treatment approaches. As described herein, the feces stream, containing primarily feces, is also referred to as the “brown stream.” The brown stream is mostly feces, but can also be mixed with other liquid and solid waste. For example, the brown stream can include feces, toilet paper, some urine, and some water. As described herein, the “green stream” can include mostly water, some urine, and some toilet paper, and usually does not include feces. The green stream is mostly liquid with some solids. As described herein, the urine stream, containing primarily urine, is also referred to as the “yellow stream.” For example, a yellow stream can include urine and some water. As described herein, the wastewater stream is also referred to as the “blue stream.” For example, the blue stream can contain primarily wastewater in the form of flush water, anal rinse water, or excess water that is poured into the toilet. In some examples, the blue stream can also include some urine. Stream separation can enable lower cost and more robust treatment processes given the high degree of variability in low volume fecal deposits (recognized as primarily diarrhea), high volume urine deposits, and excessive amounts of flush and anal rinse water, given future water scarcity constraints.

In the context described above, various examples of systems and methods of mSCWO solids treatment for fecal waste streams are described herein. The micro-Super Critical Water Oxidation (mSCWO) solids treatment system can be a solids treatment system that operates separately or can be configured for use in a stand-alone non-sewered toilet system. The fecal waste streams can comprise feces, as well as urine, water, and other sanitation incidentals, such as toilet paper, contained in a waste stream collected in a toilet system. In an example, the mSCWO system can be part of a larger toilet system that can receive unrestricted rates of mixed-content human waste streams and some sanitation incidentals. The mSCWO solids treatment system can be integrated as a module for solids treatment in a stand-alone non-sewered sanitation system. In some examples, the mSCWO solids treatment system can be configured to operate as part of a single unit toilet system. For example, the mSCWO solids treatment module can be integrated for use in a single unit toilet system configured to render the bodily wastes of an adult human into water, CO₂, ammonia, and mineral ash. In some examples, the mSCWO solids treatment system can be configured to provide treated output that meets or exceeds the ISO 30500 standard.

The mSCWO solids treatment system can be used to process a feces stream or brown stream of human waste, as described herein. By separating the brown stream prior to input, the mSCWO solids treatment system can operate to process the solids contained therein. Moreover, a brown stream slurry or feces slurry can be obtained by removing excess fluid from the brown stream and homogenizing the contents. For example, a feces slurry can be obtained from a separation and homogenization system connected to the mSCWO solids treatment system.

The method and system for mSCWO solids treatment can include a batchwise process that heats and pressurizes a slurry of human waste to or above the critical point of water into the super critical fluid phase, killing all pathogens and reducing the complex organic molecules to simple chemical building blocks. The slurry of human waste, also referred to as a feces slurry or brown stream slurry herein, can comprise bodily wastes of a human, including urine and feces, as well as sanitation incidentals. The mSCWO solids treatment system can be configured to receive a feces slurry from at least one separation or treatment system that processes bodily wastes of a human comprising urine and feces. For example, at least one separation or treatment system can partially separate liquid from a mixed content waste, reducing the amount of liquid in a feces stream or brown stream delivered to the mSCWO solids treatment system. For example, at least one separation or treatment system can comprise a homogenizer configured to form the feces slurry. The feces slurry can have a composition that is mostly solids with a liquid component. The liquid component can include urine, flush water, rinse water, wash water, fresh water, consumable water, potable water, and the like. In some examples, a portion of the liquid component of the bodily wastes can be processed separately prior to or in conjunction with the at least one homogenizer system that forms the feces slurry.

The feces slurry can be received as a slurry batch in an injector of the mSCWO solids treatment system, where it can be pressurized using compressed air. For example, the pressurized slurry batch can be injected into a mSCWO reactor. After receiving the slurry batch, the mSCWO reactor can be heated to or above the critical point of water into the super critical fluid phase over a heating time. The critical point of water is 374° C. and 221 bar. For example, the mSCWO reactor can be heated to or above the critical point of water into the super critical fluid phase over approximately 2-3 minutes. The mSCWO reactor can maintain this state for holding time for in treatment to inactivate pathogens. For example, the holding time can be maintained at this state for about 8-10 minutes. After the holding time has expired, an mSCWO effluent can be ejected, where the mSCWO effluent is a pathogen reduced or pathogen free output. The mSCWO effluent can comprise a mixture of solid ash and liquid waste. Once the reactor cycle is complete and the slurry has been processed, the pathogen free reactor output can be ejected into a phase separator of a concentrator module. The concentrator module can comprise a combined concentrator and phase separator configured to separate solid ash from the liquid waste and gaseous products. The combined concentrator and phase separator can recover energy from the mSCWO effluent. The solid waste of the separated effluent can be transported to the drying belt in a drying tunnel, where it is dried and then transported to a disposal bin for removal from the system, and the liquid waste can be transported for further treatment or processing in a liquid waste treatment system, such as a urine and wastewater treatment system.

In the following discussion, a general description of the mSCWO solids treatment system and components is provided, including a discussion of the operation of the same. Non-limiting examples of a mSCWO solids treatment system are discussed. In some examples, the configuration can include optional connections to integrate the mSCWO solids treatment system with other systems comprising a stand-alone non-sewered sanitation system. For example, the mSCWO solids treatment system can integrate with a buffer tank separation system and/or a urine and wastewater treatment system.

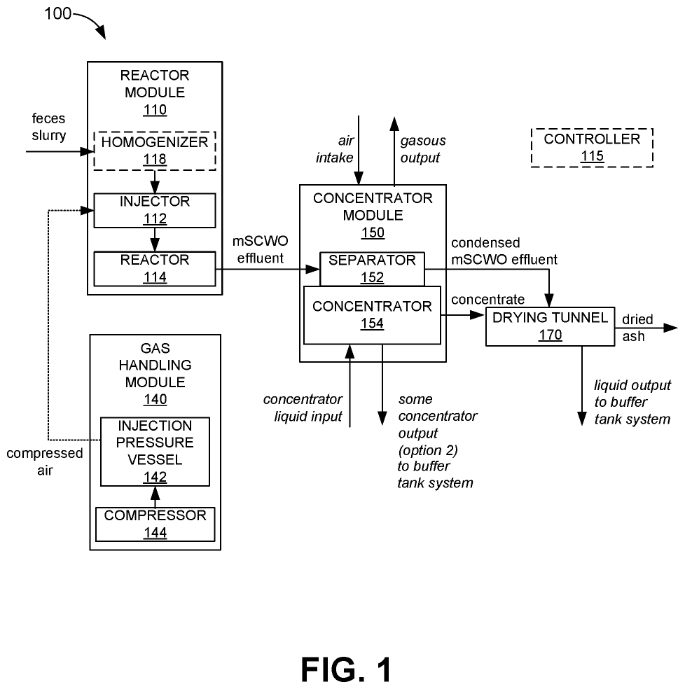

As shown in FIG. 1, the mSCWO solids treatment system 100 can include a reactor module 110, a gas handling module 140, and a concentrator module 150. The mSCWO solids treatment system 100 can be configured to receive and process a solids slurry comprising at least feces, also referred to as a feces slurry herein. The feces slurry can be received from a tank, for example a separation system configured to interface with the mSCWO solids treatment system 100. For example, the mSCWO solids treatment system 100 can receive a feces slurry from a buffer tank separation and homogenization system of a single unit toilet system. In some examples, the feces slurry can be mixed, macerated, or ground prior to delivery to the mSCWO solids treatment system 100. In some examples, the feces slurry can be optionally received into a homogenizer 118 of the reactor module 110, wherein the solids of feces slurry are broken down further. The brown stream slurry or feces slurry comprises feces and at least one of: urine, toilet paper, and water. Where the water can be wash water, flush water, fresh water, consumable water, potable water, and the like. For example, the total dry solid mass fraction of the brown stream slurry can range from about 7-12%. For example, in a day, the brown stream collected can have a mass of 3.967 kg with the total dry solids being 0.374 kg, resulting in a 9.4% solid mass fraction.

The reactor module 110 can include an injector 112 and an mSCWO reactor 114. In some examples, the reactor module 110 can also include a homogenizer 118. In some examples, a feces slurry can be received directly into the injector 112 from another system. In another example, as shown in FIG. 1, the feces slurry can also be received into reactor module 110 via the homogenizer 118. The optional homogenizer 118 can comprise a grinder or a macerator to further breakdown larger solids within the slurry received prior to delivery to the injector. The homogenizer 118 can be in fluid connection with the injector 112.

The injector 112 can be configured to receive a batch or dosing volume of the feces slurry. A volume of compressed air can be received from the gas handling module 140 to move the volume of feces slurry from the injector 112 to the mSCWO reactor 114. The gas handling module 140 can include an injection pressure vessel 142 and a compressor 144. The injection pressure vessel 142 can have a constant volume, where the pressure and temperature can vary. In some examples, the gas handling module 140 can include sensors to measure the temperature, pressure, and heat of the injection pressure vessel 142. In some examples, the gas handling module 140 can optionally include an oxygen concentrator. The injector 112 can be configured to deliver a batch or dosing volume of feces slurry to the mSCWO reactor 114. For example, the gas handling module 140 can provide about 7 to 8 liters of air at 200 bar for a 22 ml feed. The injector 112 can be configured to provide the reactor with an amount of oxygen for a subsequent wet oxidation, where the oxygen can be delivered as compressed air.

The mSCWO reactor 114 can be configured to contain a volume of feces slurry to be treated. After receiving the slurry batch, the mSCWO reactor 114 can be heated to a temperature at or above the critical point of water over a heating time. The temperature can be above a wet oxidation ignition temperature. For example, the mSCWO reactor 114 can be heated to or above the critical point of water into the super critical fluid phase of water over approximately 2 minutes. The mSCWO reactor 114 can maintain the temperature at or above the critical point of water into the super critical fluid phase for a holding time to remove pathogens. For example, the holding time can be maintained at this state for about 8 to about 10 minutes. After the holding time has expired, an effluent or the pathogen free output can be ejected. The pathogen free reactor output or mSCWO effluent can comprise a mixture of solid ash and liquid waste. The mSCWO solids treatment system 100 can also include various sensors, valves, pumps, and control devices not shown in FIG. 1. The mSCWO solids treatment system 100 can comprise a controller 115 configured to control the operation of various sensors, valves, pumps, and control devices.

The concentrator module 150, also called a combined concentrator and separator herein, can comprise a separator 152 and a concentrator 154. The concentrator module 150 can include a separator 152, also called a phase separator 152 herein, configured to receive an mSCWO effluent from the mSCWO reactor 114. In some aspects, the separator 152 can be a phase separator and can also comprise a heat exchange portion, such as a heating surface. Once the reactor cycle is complete and feces slurry has been processed, the mSCWO effluent can be ejected into phase separator 152 of the concentrator module 150. The mSCWO effluent being the treated output of the mSCWO reactor 114. The phase separator 152 can be configured to separate solid ash from the liquid and gaseous effluent. The separator 152 of the concentrator module 150 can be configured to extend into the interior volume of a concentrator 154, or surround a portion of the concentrator vessel 156, forming a combined unit. In some examples, the concentrator 154 of the concentrator module 150 can receive a liquid input from another system. For example, when the mSCWO solids treatment system is connected within a single unit toilet system, the liquid input can be received from a liquid treatment system, such as a urine and wastewater treatment system, connected to the mSCWO solids treatment system. The phase separator 152 can act as a heat exchanger configured to operate in conjunction with the concentrator 154 to utilize the heat from the mSCWO effluent to heat and condense the liquid waste contained within the concentrator 154. The concentrator module 150 is described in further detail herein. During operation, the phase separator 152 and the concentrator 154 can produce off gases. For example, the phase separator 152 can release carbon dioxide (CO₂) and the concentrator 154 can produce water vapor. The off gases can be filtered and output to the environment. For example, the gaseous output can comprise CO₂, CO, H₂O, and NO₂, as well as other nitrogen or sulfur oxides and the like. In some examples, the gaseous output of concentrator module 150 is configured to filter the gaseous output meet or exceed the ISO 30500 standard.

The drying tunnel 170 can comprise a dryer belt 190 configured to receive a condensed mSCWO effluent from the phase separator 152 of the concentrator module 150. An ash sludge can be separated from the condensed mSCWO effluent on the dryer belt 190 and processed to a dried ash. In an example, the dried ash output from the mSCWO solids treatment system 100 can meet or exceed the ISO 30500 standard. In an example, fluid separated from the condensed mSCWO effluent can be output to another system for further processing. In an example, the drying tunnel 170 can be configured with an outlet to send excess fluid backflow from the drying process of the dryer belt 190 to a connected buffer tank system. The concentrator module 150 can also output a concentrate formed from the liquid or liquid waste received into the concentrator 154 of the concentrator module 150. For example, the concentrate output can be delivered to dryer belt 190 in the drying tunnel 170 and dried as solids waste in a similar manner as the ash sludge. In some examples, a second option can include returning the concentrate output to another system for further processing. For example, some concentrate from the concentrator 154 can be delivered to a buffer tank separation system.

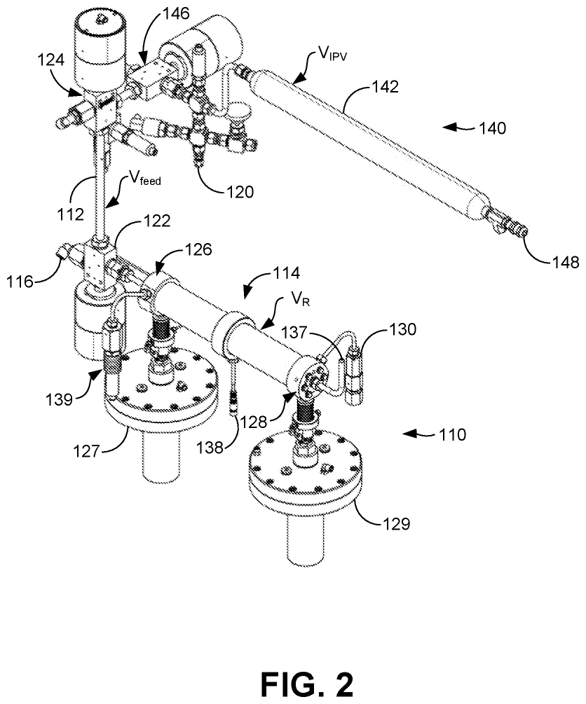

An example portion of a mSCWO solids treatment system 100 is shown in greater detail in FIG. 2. As shown, this example illustrates a portion of a gas handling module 140 connected to a reactor module 110. Compressed air can be received into the injection pressure vessel 142 from the compressor 144 (not shown) via the compressed air inlet 120. The injection pressure vessel 142 can have a constant volume and allow release of pressure via a pressure relief valve 148, if needed. In this example, the injection pressure vessel 142 can have a volume (V_{IPV}) of 500 ml. The pressure within the injection pressure vessel 142 can be about 150-160 bar. The gas handling module 140 can further comprise an injection valve 146 to regulate the compressed air input into the injector 112. Similarly, dosing valves 122, 124 allow the flow of a feces slurry into and out of the injector 112. For example, the feces slurry can be received from a connected separation and homogenization system or an optional homogenizer 118 (not shown) via an inlet 116. In this example, the injector 112 can have dosing volume (V_{feed}) of about 10-15 ml. The dosing volume can be injected as a slurry batch into the mSCWO reactor 114. The inlet valve 126 and outlet valve 128 for the mSCWO reactor 114 can be actuated by valve actuators 127, 129, respectively. The mSCWO reactor 114 can be configured to include a temperature sensor 138 and a pressure sensor 139 to measure the temperature and pressure within the mSCWO reactor 114.

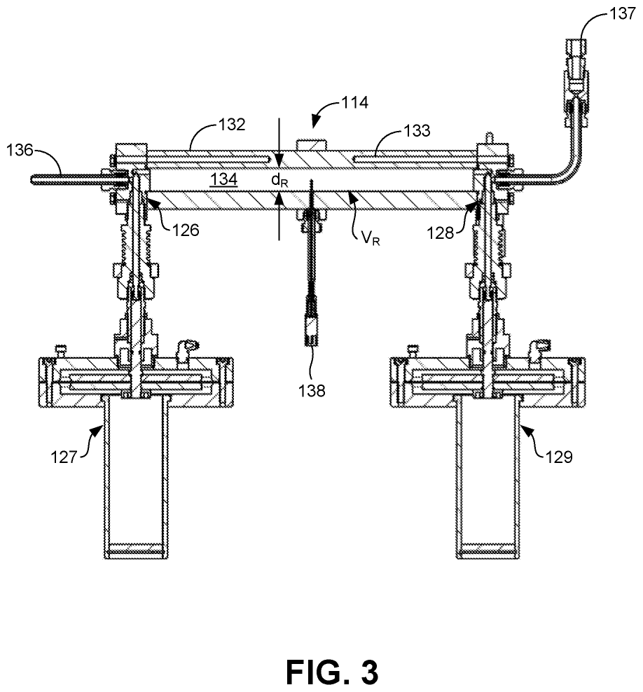

FIG. 3 illustrates an example of a cross sectional view of a mSCWO reactor 114. As shown, the reactor body 132 surrounds the reactor vessel 134. In this example, the mSCWO reactor 114 can have a volume (V_{R}) of about 150 ml with a diameter (d_{R}) of less than 34 mm. The reactor body 132 can comprise a heater or can be embedded with heating elements 133. The reactor vessel 134 can be configured to receive an injection of a slurry batch from the injector 112 (not shown) and an input of compressed air to be heated to a temperature over a heating time, where the temperature being at or above the critical point of water into the super critical fluid phase. For example, the reactor vessel can have a volume of about 95 to 150 ml. The input can be received into the reactor vessel 134 via inlet 136, and once the reactor cycle is complete and feces slurry has been processed, the mSCWO effluent can be ejected via outlet 137. The inlet valve 126 and outlet valve 128 for the reactor vessel 134 can be actuated by valve actuators 127, 129, respectively.

In this example, the mSCWO reactor 114 can be configured to obtain treatment parameters including a temperature (T_{R}) of about 400° C. to about 450° C., a pressure (PR) of less than 350 bar, and a treatment period of (T_{R}) of about 150 s to 200 s. The mSCWO reactor 114 can be insulated to contain the heat. The mSCWO reactor 114 can be configured to include a temperature sensor 138 and a pressure sensor 139 to measure the temperature and pressure within the reactor vessel 134 of the mSCWO reactor 114. The reactor module 110 can further comprise a safety burst disc 130 to release pressure from the reactor vessel 134. The reactor module 110 can also include a pressure balance line. The treated output of the mSCWO reactor 114 can be received into the separator 152 of the concentrator module 150. In this example, the separator 152 can have a volume of about 4 1 and the walls of the separator 152 can be a heating surface configured as a heat exchanger.

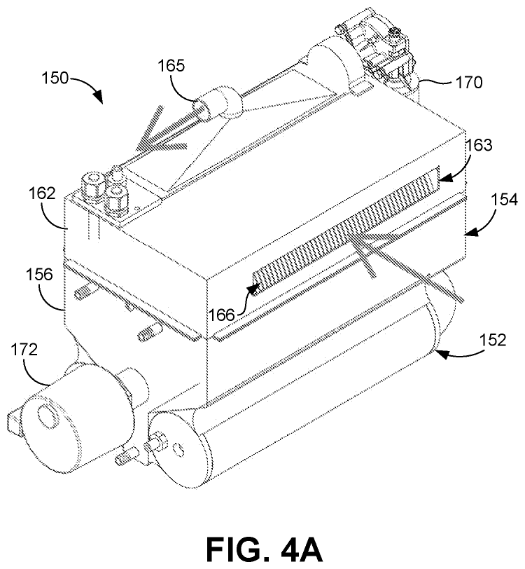

FIGS. 4A and 4B illustrate the concentrator module 150 of the mSCWO solids treatment system 100. The concentrator module 150 can include a concentrator 154 and a separator 152. The separator 152 can be configured to receive the treated slurry batch or mSCWO effluent from the mSCWO reactor 114. The concentrator module 150 can also be a pasteurization and evaporation module that can interface with a concentrate tank of a liquids treatment system. For example, the liquids treatment system can output rejected fluids that contain solids and cannot be treated in the liquids treatment system. The rejected fluids can be reduced in volume by heating the fluids in the concentrator 154. In an example, pressurized air can be introduced into the concentrator such that humidified air and/or an off gas is released, and a concentrate remains. For example, when mSCWO solids treatment system 100 is part of a non-sewered single unit toilet system, the concentrator 154 can receive rejected fluids containing salts and/or other particulate solids from a liquids treatment system. The fluids contained within the concentrator 154 can also be heated, at least in part, by the separator 152 of the concentrator module 150.

The concentrator module 150 can be configured to utilize heat from the treated output of the mSCWO reactor 114 to heat a heating surface of the separator 152, which can heat the fluid contained within the concentrator vessel 156 of the concentrator 154. In an example, the separator 152 can be configured to extend into the concentrator vessel 156 such that the fluid within the concentrator vessel 156 can be in contact with heating surface of the separator 152. In another example, as shown in FIG. 4B, the separator 152 can be positioned external to the concentrator vessel 156 such that at least a portion of the heating surface of the separator 152 is in contact with the concentrator vessel 156 to transfer heat to the fluid contained within the concentrator vessel 156. The heat from the mSCWO effluent or treated output can be transferred to the walls of the separator 152. The ash from the treated output and condensed effluent can be delivered from the separator 152 to the dryer belt 190, where the ash sludge settles on the dryer belt 190 of the drying tunnel 170.

As shown in FIG. 4A, the concentrator module 150 can comprise an open concentrator vessel 156 configured to hold a volume of fluid and a plurality of discs 166 housed within the open concentrator vessel 156. As shown in the cross-sectional view in FIG. 4B, the plurality of discs 166 can be arranged about an axle 168 that can be rotated by a motor 169 such that at least a portion of the plurality of discs 166 can be wetted by the fluid as the axle 168 rotates. Although the separator 152 can be configured to transfer heat to heat the fluid within the concentrator vessel 156, the concentrator module 150 can also include a heater 172 comprising heating coils 174 for supplemental heat, if needed. As shown in FIG. 4B, the heater 172 can be positioned such that heating coils 174 extend into the open concentrator vessel 156 to heat the volume of fluid contained within the open concentrator vessel 156. In some examples, the concentrator module 150 can also include an enclosure 162 positioned over the open concentrator vessel 156. In some examples, the concentrator module 150 can further comprise an air intake 163 and an air outlet 165 to provide air flow over the plurality of discs 166, that are wet, to aid in evaporation of the fluids to be concentrated. For example, a blower or one or more fans (not shown) can direct air flow through the concentrator 154. As shown in FIG. 4A, the enclosure 162 can be positioned to draw air through the concentrator vessel 156 and over the plurality of discs 166. The air intake 163 can be at a gap between the open concentrator vessel 156 and the enclosure 162. In another example, a system blower (not shown) can provide airflow in a similar manner over the plurality of discs 166 to aid in evaporation of the fluids to be concentrated.

In some examples, the concentrator 154 can receive a can receive a volume of rejected fluids containing salts and/or other particulate solids from a liquids treatment module. The volume of fluid can be contained by the open concentrator vessel 156. The volume of fluid can be maintained at a level that does not flow over or interfere with the rotation of the axle 168. The volume of fluid can be heated by the separator 152 and/or the heating coils 174 of the heater 172 to aid in evaporation of the fluid. In an example, pressurized air can be introduced into the concentrator such that humidified air and/or an off gas is released, and a concentrate remains. As the plurality of discs are rotated through the heated volume of fluid, the air intake 163 can be configured to direct air into the concentrator 154 over the plurality of discs 166 such that the fluid evaporates leaving the solids of the fluid received. The arrows shown in FIG. 4A indicate a direction of air flow for evaporation in one example. In another example, the air intake 163 and air outlet 165 can be reversed such that the air flow is provided in the opposite direction. For example, a blower can be configured to draw air through the concentrator 154 or to operate in a reverse direction to blow air into the concentrator 154 and out the gap between the open concentrator vessel 156 and an enclosure 162.

In one example, the concentrate from the concentrator vessel 156 can be delivered to the dryer belt 190 and/or added to the ash sludge received on the dryer belt 190, to remove remaining moisture content. In an example, the dryer belt 190 can receive a concentrate from the concentrator 154 in addition to the effluent or ash sludge from the separator 152. For example, the dryer belt 190 be positioned in a drying tunnel 170 configured to force air onto the concentrate and/or ash sludge. For example, the drying tunnel 170 can evaporate up to 4 L/day or more of concentrate and/or ash. In some examples, the drying tunnel 170 can further comprise a means to discharge gas. In another example, up to 50% of the volume contained within the open concentrator vessel 156 can be returned to a buffer tank system or other treatment module for further processing.

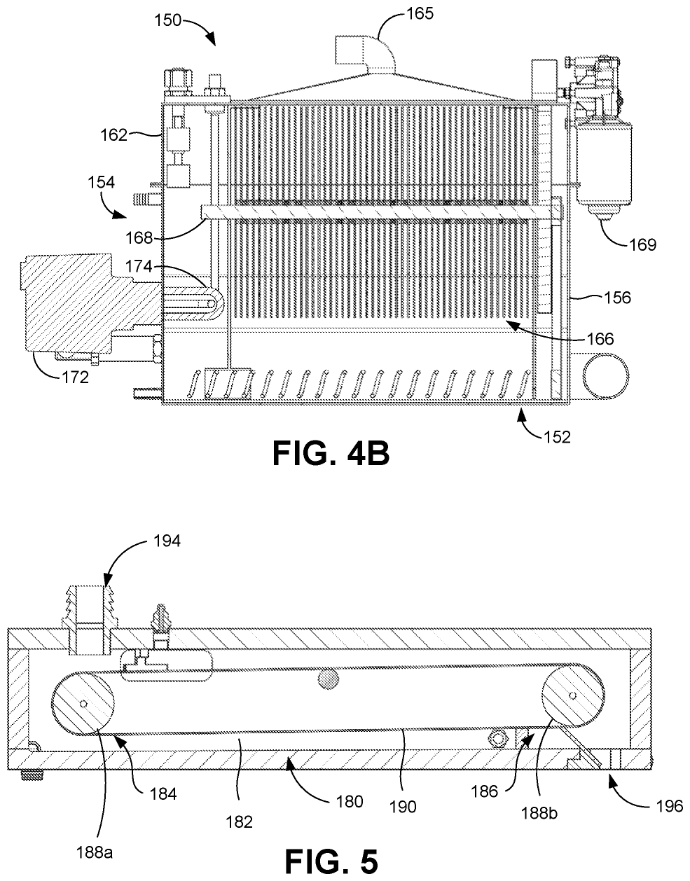

As shown in FIG. 5, the drying tunnel 170 can comprise dryer belt 190 housed in a contained air duct system 182 to force air over the ash sludge and/or concentrate (not shown) to provide evaporative drying of the ash during transport. The drying tunnel 170 having a proximal end 184 and a distal end 186, with the dryer belt 190 extending about rollers 188a, 188b positioned at each of the proximal and distal ends 184, 186. The ash sludge and/or concentrate can be received in the drying tunnel 170 at the proximal end 184 via tunnel inlet 194. The dryer belt 190 is configured to convey the ash sludge from where the ash sludge is delivered from the separator 152 the proximal end 184 to the distal end 186, where the ash is released into a solids disposal bin via tunnel outlet 196. In some examples, the dryer belt 190 is arranged with an incline from the proximal end 184 to the distal end 186. In some examples, the dryer belt 190 can comprise holes or perforations to allow air flow. For example, the dryer belt 190 can be made of a polymer mesh or a metal mesh. The mSCWO solids treatment system 100 can also include a solids disposal bin to receive the dried ash or dried concentrate.

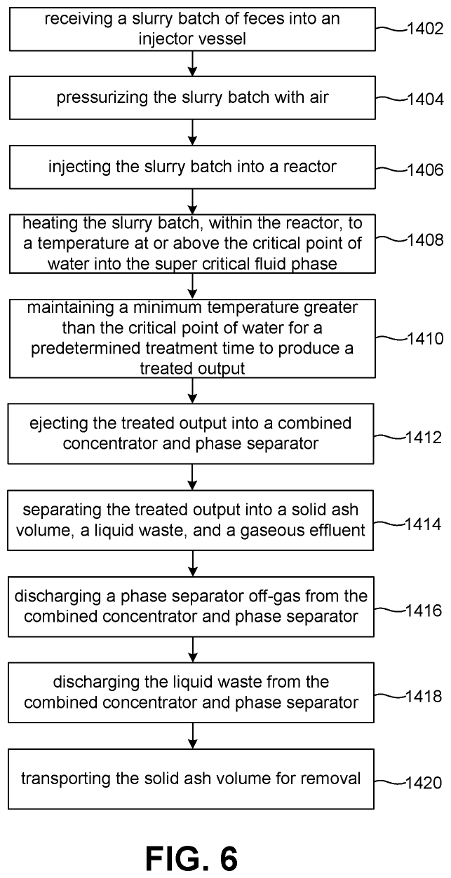

FIG. 6 shows an example method for treatment of human waste as described herein. At box 1402, the method can include receiving a slurry batch of feces into an injector vessel. For example, the slurry batch can be received from a collection tank, a homogenizer, or a separate system that preprocesses the feces slurry. In an example, the slurry batch can be received in an optional homogenizer of the reactor module before being delivered into the injector vessel.

At box 1404, the method can include pressurizing the slurry batch with air. At box 1406, the method can include injecting the slurry batch into a reactor and providing the reactor with a sufficient amount of oxygen for a subsequent wet oxidation. The oxygen provided can be a volume of compressed air.

At box 1408, the method can include heating the slurry batch, within the reactor, for a heating time to a temperature that is at or above the critical point of water into the super critical fluid phase. The critical point of water is 374° C. and 221 bar. The temperature can be a predetermined temperature above the wet oxidation ignition temperature.

At box 1410, the method can include maintaining the slurry batch at a minimum temperature, within the reactor, for a predetermined treatment time to produce a treated output, wherein the minimum temperature is greater than the critical point of water. At box 1412, the method can include ejecting the treated output into a phase separator. The treated output being an effluent comprising a liquid and ash.

At box 1414, the method can include separating the treated output into a solid ash volume, a liquid waste, and a gaseous effluent. In some examples, the method can further include releasing the treated output. For example, at box 1416, the method can include discharging a phase separator off-gas from the combined concentrator and phase separator. For example, at box 1418, the method can include discharging the liquid waste from the combined concentrator and phase separator. For example, the liquid waste can be transported to another system, such as a buffer tank system. For example, at box 1420, the method can include transporting the solid ash volume to a disposal bin for removal. In some examples, the solid ash volume is ISO 30500 compliant for solid waste output. In some examples, one or more steps can be omitted and/or added. The method can be carried out in the order recited or in any other order that is logically possible.

The mSCWO solids treatment system 100 can be configured for use in various systems and applications. As discussed above, as an example, the mSCWO solids treatment system 100 can be a solids treatment system configured for use in a stand-alone non-sewered toilet system. The mSCWO solids treatment system 100 can be configured to operate as part of and integrate with a single unit toilet system, including such systems as a liquid treatment system and/or a separation system.

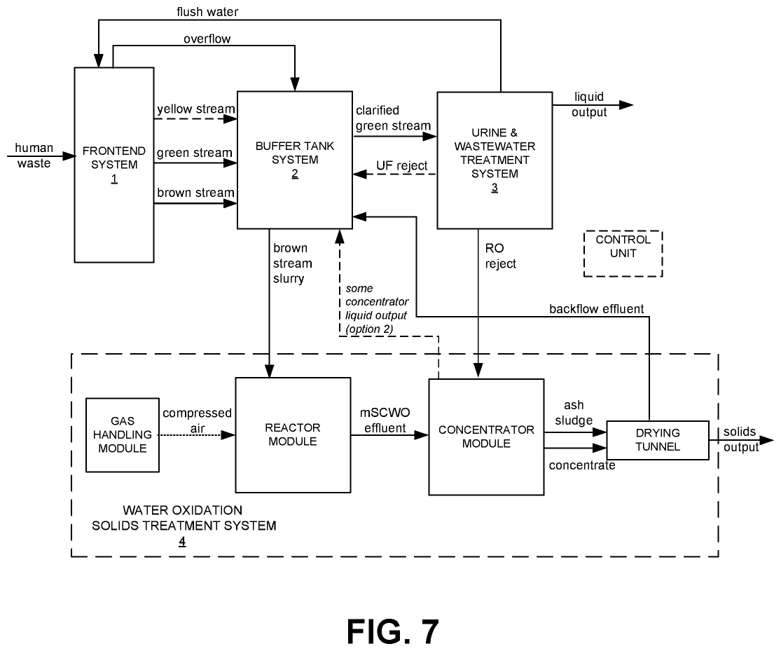

FIG. 7 illustrates an example schematic of a non-sewered single unit toilet system that includes a frontend system 1, a buffer tank system 2, a urine and wastewater treatment system 3, and a water oxidation solids treatment system 4. In this example, the water oxidation solids treatment system 4 can comprise the mSCWO solids treatment system 100 described herein. In this example, the frontend system 1 can be configured to capture the human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the water oxidation solids treatment system 4. Further, the buffer tank system 2 can receive input from one or more of the systems or modules of the single unit toilet system for additional processing. The single unit toilet system can be configured to deliver a treated liquid output and a treated solid output. Clean water and/or treated water can be also used in the system for flush water in the frontend system 1 or used for processing in one or more of the systems or modules. The single unit toilet system can further comprise control unit comprising at least one controller for the operation of the system and/or one or more modules of the system, including valves, pumps, motors, sensors, and other devices. The control unit can also comprise the controller for the mSCWO solids treatment system 100 described herein.

### Aspects

The following list of exemplary aspects supports and is supported by the disclosure provided herein.

Aspect 1. A system for treatment of fecal waste, comprising:
an injector vessel;
a reactor configured to receive an injection of a slurry batch from the injector vessel and an input of compressed air to be heated to a temperature over a heating time, the temperature being at or above the critical point of water into the super critical fluid phase; and
a combined concentrator and phase separator comprising:
a concentrator vessel configured to receive and contain a liquid to be concentrated; and
a separator configured to receive a treated output from the reactor and separate solid ash volume from liquid and gaseous effluent; and
a drying tunnel configured to receive and dry the solid ash volume.

Aspect 2. The system of aspect 1, wherein the reactor is configured to maintain the slurry batch at a minimum temperature, within the reactor, for a predetermined treatment time to produce the treated output.

Aspect 3. The system of aspect 2, wherein the minimum temperature is greater 374° C.

Aspect 4. The system of aspect 2, wherein the minimum temperature for treatment in the reactor ranges from about 350° C. to about 450° C.

Aspect 5. The system of aspect 2, wherein the predetermined treatment time is about 150 s.

Aspect 6. The system of aspect 2, wherein the reactor is configured to maintain a pressure of about 220 bar within the reactor for the predetermined treatment time.

Aspect 7. The system of aspect 1, wherein the separator of the combined concentrator and phase separator is configured as a heat exchanger to utilize heat from the treated output to heat a heating surface of the heat exchange portion of the separator that extends into or around the concentrator vessel to heat the liquid contained therein.

Aspect 8. The system of aspect 1, wherein the combined concentrator and phase separator comprises a blower and a plurality of discs, the plurality of discs arranged about an axle and housed within the concentrator vessel configured to be rotated through the contained liquid to wet said discs, the blower positioned to direct air into the concentrator vessel toward the plurality of discs to evaporate liquid from the wet discs.

Aspect 9. The system of aspect 1, wherein the drying tunnel comprises a dryer belt housed in a contained air duct system configured to force air toward the dryer belt, the dryer belt configured to receive and dry the solid ash volume.

Aspect 10. The system of aspect 1, further comprising an injection pressure vessel configured to deliver the input of compressed air to the reactor, the input of compressed air being a volume of compressed air with an amount of oxygen for a subsequent wet oxidation of the slurry batch.

Aspect 11. A method for treatment of human waste, the method comprising:
receiving a slurry batch of feces into an injector;
pressurizing the slurry batch with air;
injecting the slurry batch into a reactor;
heating the slurry batch, within the reactor, to a temperature over a heating time, the temperature being over the temperature of the critical point of water into the super critical fluid phase;
maintaining the slurry batch at a minimum temperature, within the reactor, for a predetermined treatment time to produce a treated output, wherein the minimum temperature is greater than the critical point of water;
ejecting the treated output into a phase separator;
separating the treated output into a solid ash volume, a liquid waste, and a gaseous effluent; and
transporting the solid ash volume to a disposal bin for removal.

Aspect 12. The method for treatment of human waste of aspect 11, wherein injecting the slurry batch into the reactor further comprises providing the reactor with an amount of oxygen for a subsequent wet oxidation.

Aspect 13. The method for treatment of human waste of aspect 11, wherein the temperature is a temperature above the wet oxidation ignition temperature.

Aspect 14. The method for treatment of human waste of aspect 11, further comprising receiving a liquid to be concentrated into a concentrator.

Aspect 15. The method for treatment of human waste of aspect 11, wherein receiving a slurry batch of feces further comprises homogenizing the slurry batch prior to receiving the slurry batch into the injector.

Aspect 16. The method for treatment of human waste of aspect 11, further comprising discharging off-gasses and liquid waste from the combined concentrator and phase separator.

Aspect 17. The method for treatment of human waste of aspect 11, the minimum temperature for treatment in the reactor ranges from about 350° C. to about 450° C.

Aspect 18. The method for treatment of human waste of aspect 11, wherein the predetermined treatment time is about 150 s.

Aspect 19. The method for treatment of human waste of aspect 11, wherein maintaining the slurry batch at the minimum temperature comprises maintaining a pressure within the reactor for the predetermined treatment time.

Aspect 20. The method for treatment of human waste of aspect 11, wherein the critical point of water is 374° C. The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

1. A system for treatment of fecal waste, comprising:
an injector vessel;
a reactor configured to receive an injection of a slurry batch from the injector vessel and an input of compressed air to be heated to a temperature over a heating time, the temperature being at or above the critical point of water into the super critical fluid phase; and
a combined concentrator and phase separator comprising:
a concentrator vessel configured to receive and contain a liquid to be concentrated; and
a separator configured to receive a treated output from the reactor and separate solid ash volume from liquid and gaseous effluent; and
a drying tunnel configured to receive and dry the solid ash volume.

2. The system of claim 1, wherein the reactor is configured to maintain the slurry batch at a minimum temperature, within the reactor, for a predetermined treatment time to produce the treated output.

3. The system of claim 2, wherein the minimum temperature is greater 374° C.

4. The system of claim 2, wherein the minimum temperature for treatment in the reactor ranges from about 350° C. to about 450° C.

5. The system of claim 2, wherein the predetermined treatment time is about 150 s.

6. The system of claim 2, wherein the reactor is configured to maintain a pressure of about 220 bar within the reactor for the predetermined treatment time.

7. The system of claim 1, wherein the separator of the combined concentrator and phase separator is configured as a heat exchanger to utilize heat from the treated output to heat a heating surface of the heat exchange portion of the separator that extends into or around the concentrator vessel to heat the liquid contained therein.

8. The system of claim 1, wherein the combined concentrator and phase separator comprises a blower and a plurality of discs, the plurality of discs arranged about an axle and housed within the concentrator vessel configured to be rotated through the contained liquid to wet said discs, the blower positioned to direct air into the concentrator vessel toward the plurality of discs to evaporate liquid from the wet discs.

9. The system of claim 1, wherein the drying tunnel comprises a dryer belt housed in a contained air duct system configured to force air toward the dryer belt, the dryer belt configured to receive and dry the solid ash volume.

10. The system of claim 1, further comprising an injection pressure vessel configured to deliver the input of compressed air to the reactor, the input of compressed air being a volume of compressed air with an amount of oxygen for a subsequent wet oxidation of the slurry batch.

11. A method for treatment of human waste, the method comprising:
receiving a slurry batch of feces into an injector;
pressurizing the slurry batch with air;
injecting the slurry batch into a reactor;
heating the slurry batch, within the reactor, to a temperature over a heating time, the temperature being over the temperature of the critical point of water into the super critical fluid phase;
maintaining the slurry batch at a minimum temperature, within the reactor, for a predetermined treatment time to produce a treated output, wherein the minimum temperature is greater than the critical point of water;
ejecting the treated output into a phase separator;
separating the treated output into a solid ash volume, a liquid waste, and a gaseous effluent; and
transporting the solid ash volume to a disposal bin for removal.

12. The method for treatment of human waste of claim 11, wherein injecting the slurry batch into the reactor further comprises providing the reactor with an amount of oxygen for a subsequent wet oxidation.

13. The method for treatment of human waste of claim 11, wherein the temperature is a temperature above the wet oxidation ignition temperature.

14. The method for treatment of human waste of claim 11, further comprising receiving a liquid to be concentrated into a concentrator.

15. The method for treatment of human waste of claim 11, wherein receiving a slurry batch of feces further comprises homogenizing the slurry batch prior to receiving the slurry batch into the injector.

16. The method for treatment of human waste of claim 11, further comprising discharging off-gasses and liquid waste from the combined concentrator and phase separator.

17. The method for treatment of human waste of claim 11, the minimum temperature for treatment in the reactor ranges from about 350° C. to about 450° C.

18. The method for treatment of human waste of claim 11, wherein the predetermined treatment time is about 150 s.

19. The method for treatment of human waste of claim 11, wherein maintaining the slurry batch at the minimum temperature comprises maintaining a pressure within the reactor for the predetermined treatment time.

20. The method for treatment of human waste of claim 11, wherein the critical point of water is 374° C.
